(19) United States
(12) Patent Application Publication
(10) Pub. No.: US 2004/0141524 A1
(43) Pub. Date: Jul. 22, 2004

(54) IPv6 header receiving apparatus and IPV6 header processing method

(75) Inventors: Min-jae Lee, Seoul (KR); Yong-jun Lim, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics, Co., Ltd., Suwon-Si (KR)

(21) Appl. No.: 10/754,704

(22) Filed: Jan. 12, 2004

(30) Foreign Application Priority Data
Jan. 13, 2003 (KR) 2003-2086

(51) Int. Cl. H04J 3/22

(52) U.S. Cl. 370/469; 370/474

(57) ABSTRACT

An IPv6 header receiving apparatus and an IPv6 header processing method includes a register with a data size that is a multiple of an octet and modules for an IPv6 basic header or various types of IPv6 extended headers. The register receives IPv6 header data in units of an octet, stores the IPv6 header data, and transmits the stored IPv6 header data to an IPv6 processing module for that corresponds to the IPv6 header data. The modules receive the IPv6 header data from the register and process the IPv6 header data. Accordingly, IPv6 header data can be processed in real-time without wasting memory.

### CROSS-REFERENCE TO RELATED APPLICATIONS

This application claims the priority of Korean Patent Application No. 2003-2086, filed on Jan. 13, 2003, in the Korean Intellectual Property Office, the disclosure of which is incorporated herein in its entirety by reference.

### BACKGROUND OF THE INVENTION

1. Field of the Invention

The present invention relates to an apparatus and method of receiving and processing an IP header, and more particularly, to an IPv6 header receiving apparatus capable of being implemented in hardware and an IPv6 header processing method.

2. Description of the Related Art

To solve the growing shortage of 32-bit Internet Protocol (IP) addresses caused by the rapid increase in networking and IP nodes, the Internet Engineering Task Force (IETF) started developing an IPv6 protocol to replace an IPv4 protocol and developed an IPv6 protocol in the early 1960s. An IPv6 protocol was designed by adding new features to the IPv4 protocol, based on the experiences accumulated from the design of the IPv4 protocol.

Most parts of the IPv6 protocol are implemented in software. In other words, in conventional software implementations of the IP protocol, a packet received from a lower layer is copied and stored in memory and then processed. In the conventional software implementations of the IP protocol, data transmission between layers is achieved with a memory buffer chaining method using a pointer.

FIG. 1 shows the structure of a conventional IPv6 input module. When a MAC controller 120, which processes a data link layer and a physical layer, collects data corresponding to one frame, the MAC controller 120 uses a CRC checksum to determine whether the frame is defective. If the frame is not defective, the MAC controller 120 transmits a packet via a dedicated interrupt terminal to a machine 110. A processor 111 in the machine 110 receives data from a memory 113 using a pointer 112, processes the received data, and overwrites a location in the memory 113 with the processed data. In this way, packet processing in each layer is achieved through memory overwrites.

However, in such a software implementation of IP, memory to store a packet is indispensable, and accordingly, extra time to access the memory is required. The extra time represents a significant amount of latency with respect to a packet, and consequently, generates a considerable overhead in a TCP/IP-ported machine.

FIG. 2 shows the format of an extended IPv6 header. An IPv6 header includes a version field for a 4-bit IP version number; an 8-bit traffic class field; a 20-bit flow label field; a payload length field, which represents the length of an IPv6 payload and is composed of an unsigned 16-bit integer; a next header field, which is a 8-bit selector that identifies the type of an extended header following the IPv6 header; an 8-bit hop limit field; a 128-bit origin address field representing the source of a packet; and a 128-bit destination address field representing the destination of the packet.

An IPv6 packet may have no extended headers, one extended header, or a plurality of extended headers. Each extended header is identified by a next header field included in the previous basic or extended header. Each extended header has a length that is an 8-octet multiple.

The extended IPv6 packet shown in FIG. 2 includes 6 extended headers. If a plurality of extended headers are used in one packet, a hop-by-hop option extended header, a destination option extended header, a routing extended header, a fragment extended header, an authentication extended header, and a destination option extended header, the plurality of extended headers can be sequentially arranged between an IPv6 header and an upper layer header (not shown).

The hop-by-hop option extended header is used to transport selective information that is inspected by each node along a packet transport path.

The next header field in the hop-by-hop option extended header is an 8-bit selector and identifies the type of header immediately following the hop-by-hop option extended header. An extended header length field in the hop-by-hop option extended header is expressed with an unsigned 8-bit integer and represents the length of the hop-by-hop option extended header that is formed in units of 8 octets. The field next to the extended header length field is a variable length field, which includes an option. The next header field and the extended header length field are commonly applied to all extended headers.

The routing extended header is used to list a plurality of intermediate nodes that a packet must visit when transported from an IPv6 source to a destination.

The fragment extended header is used when a packet has a size larger than the maximum transport unit (MTU) and the packet must be transported from an IPv6 source to a destination.

The destination option extended header is used to transport selective information that is inspected by the destination node specified in the packet.

FIGS. 3A through 3C show the header structures of IPv6 implemented with various link layers. An IPv6 header over Ethernet, as shown in FIG. 3A, includes a destination Ethernet address, a source Ethernet address, and an IPv6 header & payload. An IPv6 header over a Fiber Distributed Data Interface (FDDI), as shown in FIG. 3B, includes a destination FDDI address, a source FDDI address, and an IPv6 header & payload.

An IPv6 header over a token ring, as shown in FIG. 3C, includes a destination address, a source address, and an IPv6 header & payload. As observed from FIGS. 3A through 3C, IPv6 headers are processed in units of 8 octets regardless of the type of link layer implementation.

A conventional IPv6 receiving apparatus has increased latency due to the frequency of required memory accesses. When a conventional IPv6 receiving apparatus is implemented in hardware, additional space is required to predict and count the variable extended header length.

In Korean Patent Publication No. 2002-34230, filed on Jun. 19, 2002 and published on Sep. 5, 2002, entitled “IPv6 implementing apparatus and a physical medium interface unit, an IPv6 header processing unit, and an upper layer interface unit which are used in the IPv6 implementing apparatus”, IPv6 and ICMPv6 protocols, which are normally processed by software or the operating system (OS), are implemented in hardware in real time without a loss in communication speed. In the IPv6 protocol implementing apparatus, the physical medium interface unit is connected to a physical interface layer. The IPv6 header processing unit processes an IPv6 basic header and IPv6 extended headers and is connected to the physical medium interface unit. The upper layer interface unit is connected to an upper layer protocol, such as, TCP or UDP.

Korean Patent Publication No. 2002-34230 discloses an IPv6 implementing apparatus which is implemented in hardware. However, a structure in which an IPv6 header is received and stored is not specified.

### SUMMARY OF THE INVENTION

Various aspects and/or advantages of the invention will be set forth in part in the description which follows and, in part, will be obvious from the description, or may be learned by practice of the invention.

In accordance with an aspect of the present invention, there is provided an IPv6 header receiving apparatus capable of processing an IPv6 header in real time without wasting memory and an IPv6 header processing method.

According to an aspect of the present invention, there is provided an IPv6 header receiving apparatus including a register with a data size that is a multiple of an octet, which receives IPv6 header data in units of an octet, stores the IPv6 header data, and transmits the stored IPv6 header data to a module for processing an IPv6 header that corresponds to the IPv6 header data, and modules for an IPv6 basic header or various types of IPv6 extended headers, which receive the IPv6 header data from the register and process the IPv6 header data.

According to an aspect of the present invention, there is also provided an IPv6 header receiving apparatus comprising a counter, which counts up to an amount of IPv6 extended header data that can be transmitted in units of an octet at a time, a register with a data size that is a multiple of an octet, which receives IPv6 header data in units of an octet, stores the IPv6 header data, and, if the counter has completed counting up to the specified amount, transmits the stored IPv6 header data to a module for processing an IPv6 header that corresponds to the IPv6 header data, and modules for an IPv6 basic header or various types of IPv6 extended headers, which receive the IPv6 header data from the register and process the IPv6 header data.

According to an aspect of the present invention, there is also provided an IPv6 header receiving apparatus comprising an octet indicator, a register with a data size that is a multiple of an octet, a controller, and modules for an IPv6 basic header or various types of IPv6 extended headers. The octet indicator counts up to an amount of IPv6 extended header data that can be transmitted in units of an octet at a time. The register receives IPv6 header data in units of 8 octets and stores the IPv6 header data. The control unit analyzes the IPv6 header data stored in the register to determine a type and length corresponding to the IPv6 header data. If the octet indicator has completed counting up to the specified amount, the control unit causes transmission of the IPv6 header data with the determined length to a module for processing an IP header that corresponds to the IPv6 header type. The modules for an IPv6 basic header or various types of IPv6 extended headers receive the IPv6 header data from the register and process the IPv6 header data.

According to another aspect of the present invention, there is provided an IPv6 header processing method which includes filling a register with IPv6 header data received in units of a predetermined size, which is a multiple of an octet, identifying an IPv6 header type by analyzing the IPv6 header data filled in the register, and transmitting the IPv6 header data to a module corresponding to the identified IPv6 header type.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 shows an example of the structure of a conventional IPv6 input module;

FIG. 2 shows the format of an extended IPv6 header;

FIGS. 3A through 3C show the header structures of IPv6 implemented with various link layers;

FIG. 4 is a block diagram of an IPv6 header receiving apparatus according to an embodiment of the present invention;

FIG. 5 shows the detailed structure of the next header status register of FIG. 4; and

FIG. 6 is a flowchart for illustrating an IPv6 header processing method according to an embodiment of the present invention.

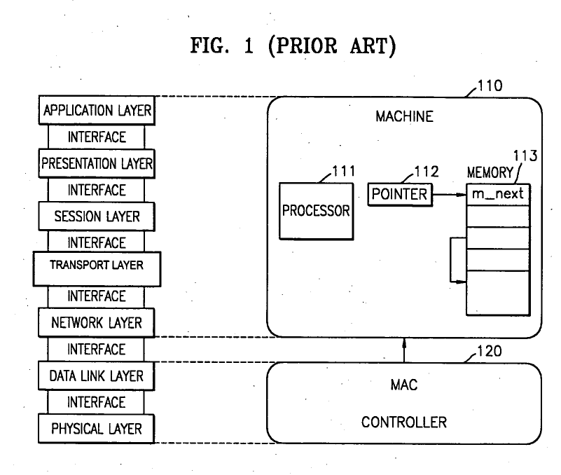

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

Because processing of an IPv6 header format is based on 8 octets, an IPv6 implementing apparatus according to the present invention is implemented in hardware using an extra device that can monitor 8 octets.

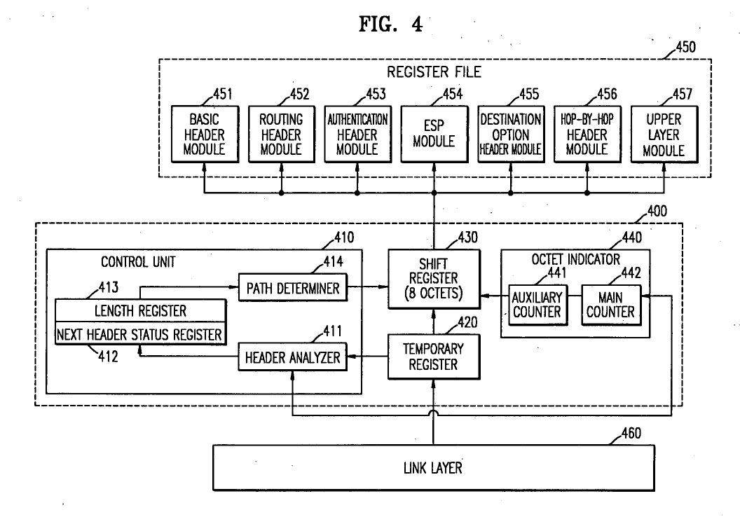

Referring to FIG. 4, an IPv6 header receiving apparatus according to an embodiment of the present invention includes an IP receiving module 400 and a register file 450. The IP receiving module 400 receives an IPv6 header in units of 8 octets and transports the received 8 octets of data to the register file 450. The register file 450 receives and processes the IPv6 header.

The IP receiving module 400 includes a control unit 410, a temporary register 420, a shift register 430, and an octet indicator 440. The temporary register 420 receives data, the amount of which depends on the type of interface, from a link layer 460 and stores the received data. For example, if a PCMCIA interface is used, the size of the temporary register 420 would be 2 octets.

The control unit 410 analyzes data immediately after the data is stored in the temporary register 420, issues a transport command for transmitting data to the shift register 430, and informs the octet indicator 440 of the data amount to be dynamically received.

To be more specific, the control unit 410 includes a header analyzer 411, a next header status register 412, a length register 413, and a path determiner 414.

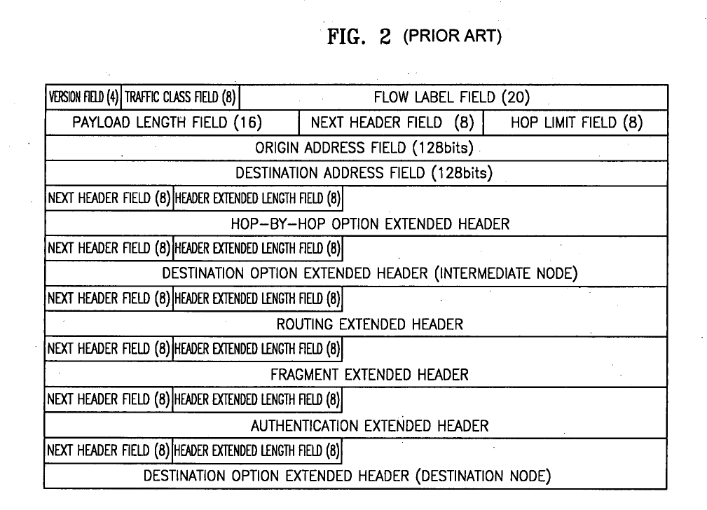

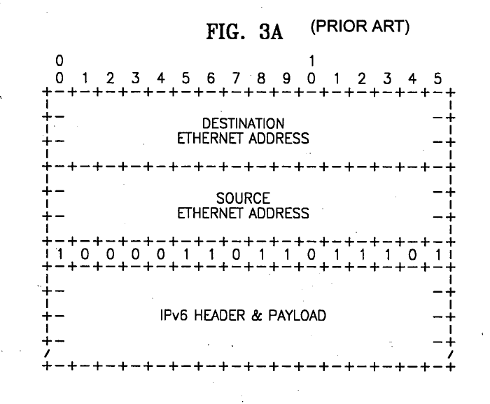

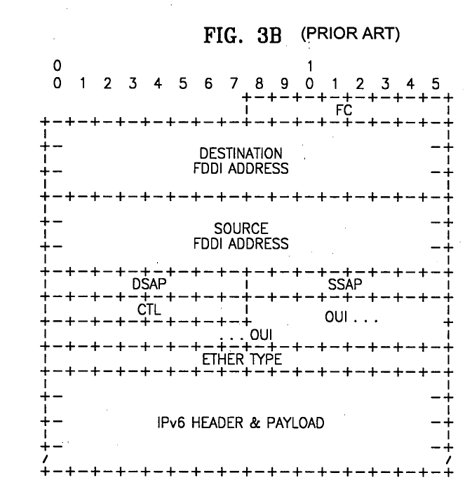

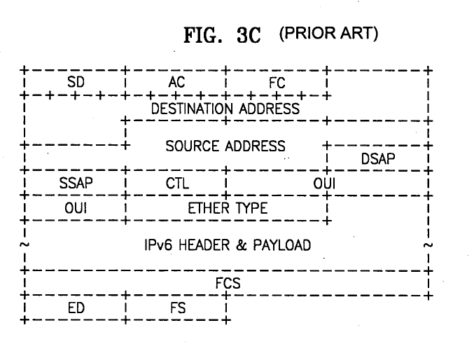

The header analyzer 411 analyzes data received from the temporary register 420, ascertains the type and length of a header corresponding to the data, and sets the next header type and next header length in the next header status register 412 and the length register 413, respectively. To be more specific, an extended IPv6 header as shown in FIG. 2 includes an 8 bit next header field and an 8-bit extended header length field. The type of the next extended header following a current extended header can be ascertained from the next header field, and the length of the next extended header can be ascertained from the extended header length field. These analysis results are set in the next header status register 412 and the length register 413.

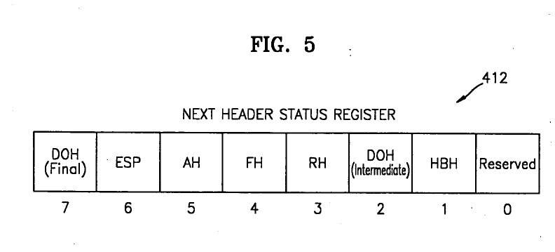

The next header status register 412 stores data representing the types of existing extended headers. The detailed structure of the next header status register 412 is shown in FIG. 5.

Referring to FIG. 5, the next header status register 412 includes a destination option header (DOH) bit (a destination node bit), an encapsulating security payload (ESP) bit, an authentication header (AH) bit, a fragment header (FH) bit, a routing header (RH) bit, a DOH bit (an intermediate node bit), a hop-by-hop header (HBH) bit, and a reserved bit. If an extended header exists, the corresponding bit is set to true. When packet processing is concluded, each bit is set to false.

Such a next header status register provides the field information necessary for checksum calculation on a network layer and provides a control signal that is used when an ICMP message is generated, due to an error in the header field or a problem in the networking media.

The length register 413 stores data representing the length of an extended header.

The path determiner 414 uses information stored in the next header status register 412 and the length register 413 to determine which module of the register file 450 receives the data stored in the shift register 430. Once the path determiner 414 has also determined the amount of data that should be transmitted, it instructs the shift register 430 to transmit the determined amount of data to the determined module of the register file 450.

The shift register 430 receives two octets of data at a time from the temporary register 420 and waits until 8 octets have been accumulated. When 8 octets of data have been accumulated, the shift register 430 shifts the 8-octet data to the register file 450 based on the determined information from the path determiner 414.

The octet indicator 440 receives count amount corresponding to an octet of data and continues to count until the shift register 430 receives 8 octets of data.

An auxiliary counter 441 counts up to 8 octets of data, corresponding to the amount stored in the shift register 430 and transmitted at one time to the register file 450. A main counter 442 counts the maximum effective length of each extended header. Also, the main counter 442 receives information, corresponding to the extended header length, from the header analyzer 411 and assists the shift register 430 in receiving and transmitting the correct amount of data corresponding to the extended header length to a module of the register file 450, which is capable of processing the header of the corresponding data.

The register file 450 includes a basic header module 451, a routing header module 452, an AH module 453, an ESP module 454, a DOH module 455, an HBH module 456, and an upper layer module 457.

Each of the modules of the register file 450 receives data from the shift register 430 in predetermined units. When the contents of a header have been completely received, each module processes the header.

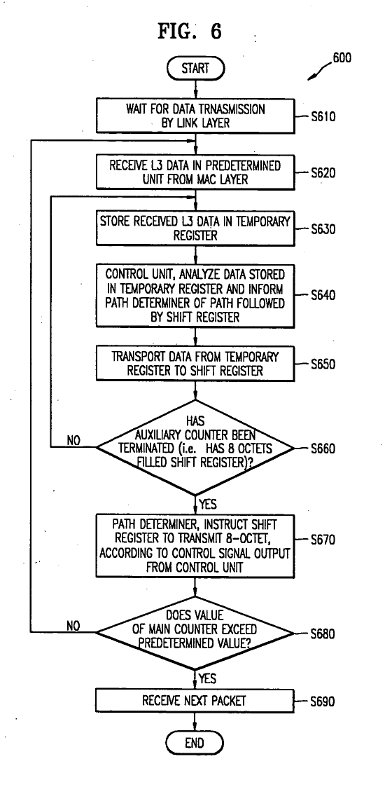

FIG. 6 is a flowchart for illustrating an IPv6 header processing method according to the present invention. First, in operation S610, the IP receiving module 400 waits for data transmission by the link layer 460.

In operation S620, a MAC layer transmits data in predetermined units to the IP receiving module 400.

In operation S630, the IP receiving module 400 stores the data in the temporary register 420. For example, the received data can be stored in units of 2 octets.

In operation S640, the header analyzer 411 of the control unit 410 receives and analyzes data stored in the temporary register 420 and causes the path determiner 414 to determine a path for data in the shift register 430. In other words, the header analyzer 411 can ascertain the type and length of an extended header next to a current header. The type of the next extended header is stored in the next header status register 412, and the length of the next extended header is stored in the length register 413. Also, the header analyzer 411 transmits information about the length of each extended header to the main counter 442 and informs the shift register 430 of the amount of data to be transmitted to each header module. The information stored in the next header status register 412 and the length register 413 are used when the path determiner 414 determines which module receives the data stored in the shift register 430.

In operation S650, the header data stored in the temporary register 420 is transported to the shift register 430.

In operation S660, it is determined whether the auxiliary counter 441 has been terminated. For example, if the size of the temporary register 420 is 2 octets, and the size of the shift register 430 is 8 octets, the auxiliary counter 441 would be terminated when the count has reached 4.

If it is determined in operation S660 that the auxiliary counter 441 has not yet been terminated, the method goes back to operation S630, in which data received from the MAC layer is stored in the temporary register 420.

If it is determined in operation S660 that the auxiliary counter 441 has been terminated, then in operation S670 the path determiner 414 instructs the shift register 430 to transmit data of 8 octets to a module of the register file 450.

In operation S680, it is determined whether the value of the main counter 442 has exceeded a predetermined value. Because the main counter 442 maintains information representing the length of the next extended header, the main counter 442 helps the shift register 430 transport all the data constituting the next extended header to a module capable of processing the next extended header.

If it is determined in operation S680 that the main counter value has not exceeded the predetermined value, that is, the length of the next extended header, the method goes back to operation S620, in which the MAC layer transmits data in a predetermined unit.

If it is determined in operation S680 that the main counter value has exceeded the predetermined value, a next packet is received, in operation S690. If the main counter value has exceeded the predetermined value, that is, if the actual amount of data received is greater than the amount of data specified as the length of the next extended header, it may be determined that an error has occurred in the extended header. In this case, instead of receiving the extended header following the current extended header, the packet corresponding to the current extended header is not used, and the next packet is received and processed.

As described above, an IPv6 receiving apparatus according to the present invention can be implemented in hardware without the need of installing a memory device. Thus, data can be processed in real time, and the data processing time, the memory capacity, and the manufacturing costs of the IPv6 receiving apparatus are reduced.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An IPv6 header receiving apparatus comprising:
a register with a data size that is a multiple of an octet, which receives IPv6 header data in units of an octet, stores the IPv6 header data, and transmits the stored IPv6 header data to an IPv6 processing module that corresponds to the IPv6 header data; and
modules for an IPv6 basic header or various types of IPv6 extended headers, which receive the IPv6 header data from the register and process the IPv6 header data.

2. An IPv6 header receiving apparatus comprising:
a counter which counts up to a specified amount of IPv6 extended header data that is transmittable in units of an octet at a time;
a register with a data size that is a multiple of an octet, which receives IPv6 header data in units of an octet, stores the IPv6 header data, and, if the counter has completed counting up to the specified amount, transmits the stored IPv6 header data to a module for processing an IPv6 header that corresponds to the IPv6 header data; and
modules for an IPv6 basic header or various types of IPv6 extended headers, which receive the IPv6 header data from the register and process the IPv6 header data.

3. An IPv6 header receiving apparatus comprising:
an octet indicator which counts up to an amount of IPv6 extended header data that can be transmitted in units of an octet at a time;
a register with a data size that is a multiple of an octet, which receives IPv6 header data in units of 8 octets and stores the IPv6 header data;
a control unit, which analyzes the IPv6 header data stored in the register to determine a type and length corresponding to the IPv6 header data, and, if the octet indicator has completed counting up to the specified amount, instructs the register to transmit the IPv6 header data with the determined length to an IP header processing module that corresponds to the IPv6 header type; and
modules for an IPv6 basic header or various types of IPv6 extended headers, which receive the IPv6 header data from the register and process the IPv6 header data.

4. The IPv6 header receiving apparatus of claim 3, wherein the register comprises:
a temporary register with a data size that is a multiple of an octet, which receives IPv6 header data in units of an octet and stores the IPv6 header data; and
a shift register, which receives the IPv6 header data in units of an octet each time from the temporary register and, if the shift register is filled with an amount of data to be transmitted at one time to a module, the shift register transmits the filled amount of data to the modules.

5. The IPv6 header receiving apparatus of claim 4, wherein the control unit comprises:
a header analyzer which receives data from the temporary register and analyzes the data;
a next header status register which stores next header type information following a current header, based on the information obtained from the analysis by the header analyzer;
a length register which stores header length information of the next header, based on the information obtained from the analysis; and
a path determiner which instructs the shift register of the amount of data to be transmitted and of the module to receive the data, the data amount specified in the header length information stored in the length register and the module specified in the next header type information stored in the next header status register.

6. The IPv6 header receiving apparatus of claim 5, wherein the octet indicator comprises:
an auxiliary counter which counts up to a data amount stored in the shift register; and
a main counter which counts up to a data amount corresponding to the header length information stored in the length register, and the control unit instructs the temporary register to receive a next packet of data if a current count of the main counter exceeds a value corresponding to the header length information.

7. The IPv6 header receiving apparatus of claim 3, wherein the modules are a basic header module, a routing header module, a destination option header module, an authentication header module, an ESP header module, a hop-by-hop header module, and an upper layer module.

8. An IPv6 header processing method comprising:
filling a register with IPv6 header data received in units of a predetermined size, which is a multiple of an octet;
identifying an IPv6 header type by analyzing the IPv6 header data filled in the register; and
transmitting the IPv6 header data to a module corresponding to the identified IPv6 header type.

9. An IPv6 header processor comprising:
a data link layer, which transmits data transmissions;
an IPv6 controller, which is responsive to header data of the data transmissions from the data link layer, and detects a type and length of the header data, and outputs the header data based on the type and length of the header data detected in the data transmissions; and
a register file having a plurality of IPv6 header modules, coupled to the IPv6 controller, each IPv6 header module receives and processes the corresponding header data transmitted by the IPv6 controller.

10. The processor of claim 9, wherein the IPv6 controller comprises:
storage registers to store the header data of data transmissions;
a counter which increments a value of an indicator when an octet of the header data is received; and
a control unit which detects the type and length of the header data, and outputs the header data from the storage registers based on the indicator value, to the corresponding IPv6 header module, wherein the corresponding IPv6 header module is determined based on the detected type and length of the header data, wherein the corresponding IPv6 header module processes the header data.

11. The processor of claim 10, wherein the storage registers and the plurality of header processors are each multiples of an octet.

12. The processor of claim 10, wherein the storage registers comprise:
a buffer register to receive data transmissions in multiples of an octet; and
a transmit register, wherein the buffer register outputs octets of header data to the transmit register where the header data is stored, and when the indicator value is equivalent to a predetermined value the contents of the transmit register are output under direction of the control unit.

13. The processor of claim 12, the control unit comprises:
a header analyzer, which receives data from the buffer register and determines a type and length of the header data;
a next header status register which stores the type of the header data determined by the header analyzer;
a length register which stores the length the header data determined by the header analyzer; and
an output path determiner responsive to the contents of the next header status register and the length register, which directs the contents of the transmit register to the corresponding header processor.

14. A method of processing header data comprising:
shifting header data into a first register in packets of lengths that are multiples of an octet;
transmitting the header data into a second register where the header data is maintained;
determining a type and length of the header data, which determines the output path of the header data maintained in the second register;
incrementing a counter each time the header data is transmitted to the second register from the first register; and
shifting the contents of the second register to a predetermined processing module by the determined output path when the counter reaches a predetermined value.

15. The method of claim 14, wherein the header data is in IPv6 format.

16. The method of claim 15, further comprising:
counting a maximum effective length of each header data; and
determining whether the maximum effective length of each header data exceeds a predetermined value, wherein if the predetermined value is exceeded a next header data packet is received.

17. The method of claim 16, wherein if the predetermined value is not exceeded, additional header data is shifted into the first register.

18. The method of claim 16, further comprising:
receiving the header data from a media access control (MAC) layer.
